(19) United States
(12) Patent Application Publication
(10) Pub. No.: US 2009/0302921 A1
(43) Pub. Date: Dec. 10, 2009

(54) APPARATUS AND METHOD FOR GENERATING CLOCK SIGNALS OF SEMICONDUCTOR INTEGRATED CIRCUIT

(75) Inventor: Jeong Tae HWANG, Ichon (KR)

Correspondence Address: BAKER & MCKENZIE LLP;PATENT DEPARTMENT, 2001 ROSS AVENUE, SUITE 2300, DALLAS, TX, 75201, US

(73) Assignee: Hynix Semiconductor Inc., Ichon (KR)

(21) Appl. No.: 12/345,458

(22) Filed: Dec. 29, 2008

(30) Foreign Application Priority Data
Jun. 4, 2008 (KR) 10-2008-0052705

(51) Int. Cl. G06F 1/04

(52) U.S. Cl. 327/295

(57) ABSTRACT

An apparatus for generating a clock signal of a semiconductor Integrated circuit includes a first clock driver block configured to generate a plurality of first clock signals, a second clock driver block configured to generate a plurality of second clock signals, and a controller configured to stop an operation of at least one of the first clock driver block and the second clock driver block when the semiconductor Integrated circuit is in a predetermined operational state.

The present application claims the benefit under 35 U.S.C. 119(a) to Korean Patent Application No. 10-2008-0052705, filed on Jun. 4, 2008, in the Korean Intellectual Property Office, which is incorporated herein by reference in its entirety as if set forth in full.

### BACKGROUND

1. Technical Field

The embodiment described herein relate to a semiconductor integrated circuit, and more particularly, to an apparatus and method for generating a clock signal of a semiconductor Integrated circuit.

2. Related Art

FIG. 1 is a schematic block diagram of a conventional device for generating a clock signal of a semiconductor Integrated circuit. In FIG. 1, the clock signal generating device 10 includes a clock buffer 1, a row clock driver block 2, and a column clock driver block 3. The clock buffer 1 functions to buffer and output external clock signals ‘CLK’ and ‘CLKB’. The output of the clock buffer 1 may be supplied to the row clock driver block 2 and the column clock driver block 3 through a tree structure. All the clock drivers included in the row clock driver block 2 and the column clock driver block 3 function to drive and output the output of the clock buffer 1.

Row clock signals output from the clock drivers of the row clock driver block 2 are supplied to circuits that generate a command, for example, active, precharge, refresh, and the like, that is associated with a row operation of the semiconductor Integrated circuit. Similarly, column clock signals output from the clock drivers of the column clock driver block 3 are supplied to circuits that generate a command, for example, write, read, auto precharge, and the like that is associated with a column operation of the semiconductor Integrated circuit.

When the semiconductor Integrated circuit performs a self refresh or auto refresh operation, a row clock signal and a column clock signal are not required. In addition, when the semiconductor Integrated circuit is in an idle state, the row clock signal is required but the column clock signal is not required. When the output of the clock buffer 1 is activated, the row clock driver block 2 and the column clock driver block 3 operate together regardless of an operational state of the semiconductor Integrated circuit.

Accordingly, power consumption may increase due to unnecessary toggling of a clock signal that occurs in a block not needed for the operation of the semiconductor Integrated circuit between the row clock driver block 2 and the column clock driver block 3.

### SUMMARY

An apparatus and method for generating a clock signal of a semiconductor Integrated circuit capable of reducing power consumption are described herein.

In one aspect, an apparatus for generating a clock signal of a semiconductor Integrated circuit includes a first clock driver block configured to generate a plurality of first clock signals, a second clock driver block configured to generate a plurality of second clock signals, and a controller configured to stop an operation of at least one of the first clock driver block and the second clock driver block when the semiconductor Integrated circuit is in a predetermined operational state.

In another aspect, an apparatus for generating a clock signal of a semiconductor Integrated circuit includes a first clock driver block configured to prevent toggling of a first clock signal in response to activation of a first control signal, a second clock driver block configured to prevent toggling of a second clock signal in response to activation of a second control signal, and a controller configured to activate at least one of the first control signal and the second control signal when the semiconductor Integrated circuit is in a predetermined operational state.

In another aspect, a method of generating a clock signal of a semiconductor Integrated circuit includes a decision operation of determining an operational state of the semiconductor Integrated circuit, and a control operation of stopping generation of at least one of a plurality of first clock signals associated with a row operation of the semiconductor Integrated circuit and a plurality of second clock signals associated with a column operation of the semiconductor Integrated circuit when it is determined the operational state of the semiconductor Integrated circuit is in a predetermined operational state.

In another aspect, an apparatus for generating a clock signal of a semiconductor integrated circuit includes a first clock driver block configured to generate a plurality of first clock signals, a second clock driver block configured to generate a plurality of second clock signals, and a controller configured to control an operation of each of the first and the second clock driver blocks according to an operational state of the semiconductor Integrated circuit.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a schematic block diagram of a conventional device for generating a clock signal of a semiconductor Integrated circuit;

FIG. 2 is a schematic block diagram of an exemplary device for generating a clock signal of a semiconductor Integrated circuit according to one embodiment;

FIG. 3 is a schematic circuit diagram of an exemplary row clock driver capable of being implemented in the device of FIG. 2 according to one embodiment;

FIG. 4 is a schematic circuit diagram of an exemplary column clock driver capable of being implemented in the device of FIG. 2 according to one embodiment;

FIG. 5 is a schematic circuit diagram of an exemplary controller capable of being implemented in the device of FIG. 2 according to one embodiment; and

FIG. 6 is a waveform diagram of an exemplary clock signal according to one embodiment.

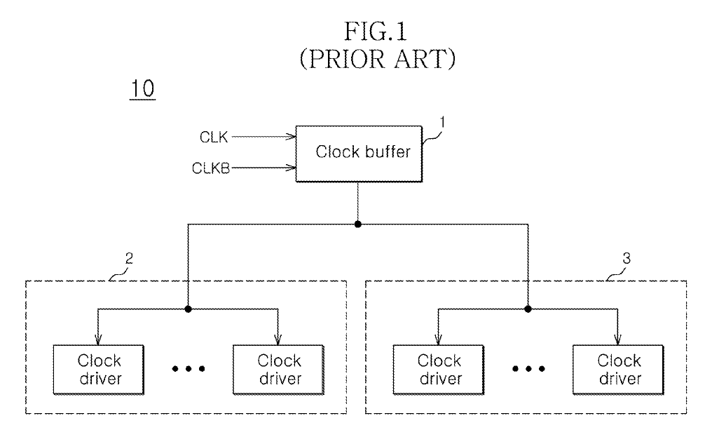

### DETAILED DESCRIPTION

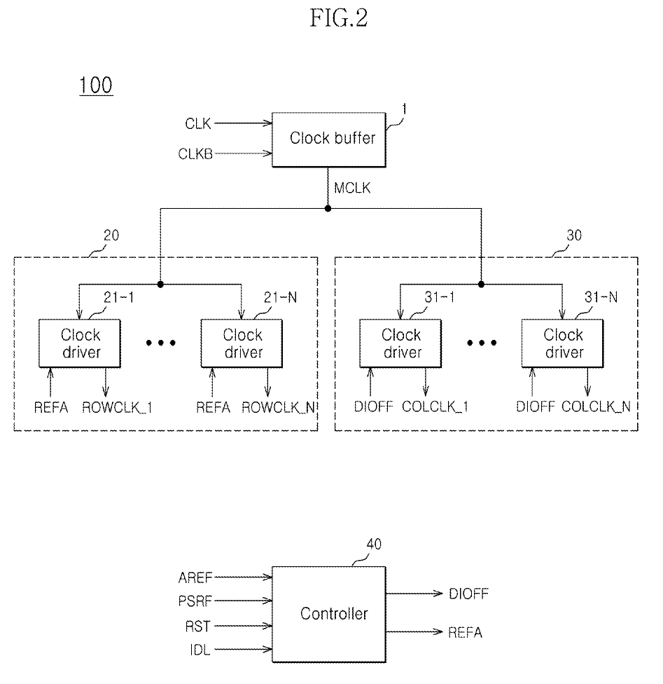

FIG. 2 is a schematic block diagram of an exemplary device for generating a clock signal of a semiconductor Integrated circuit according to one embodiment. In FIG. 2, a clock signal generating device 100 can be configured to include a clock buffer 1, a first clock driver block, that is, a row clock driver block 20, a second clock driver block, that is, a column clock driver block 30, and a controller 40.

The clock buffer 1 can function to buffer and output external clock signals ‘CLK’ and ‘CLKB’. Here, an output signal ‘MCLK’ of the clock buffer 1 can be supplied to the row clock driver 20 and the column clock driver block 30 through a tree structure.

The row clock driver block 20 can function to drive the output signal ‘MCLK’ of the clock buffer 1 according to a first control signal ‘REFA’ to generate first clock signals ‘ROWCLK<1:N>’. The first clock signals ‘ROWCLK<1:N>’ may be supplied to circuits that generate commands, i.e., active, precharge, refresh, MRS, and the like, that can be associated with a row operation of the semiconductor Integrated circuit.

For example, the row clock driver block 20 can include a plurality of clock drivers 21-1 to 21-N.

The column clock driver block 30 can function to drive the output signal ‘MCLK’ of the clock buffer 1 according to a second control signal ‘DIOFF’ to generate second clock signals ‘COLCLK<1:N>’. The second clock signals ‘COLCLK<1:N>’ can be supplied to circuits that generate commands, i.e., write, read, auto precharge, and the like, that can be associated with a column operation of the semiconductor Integrated circuit. For example, the column clock driver block 30 can include a plurality of clock drivers 31-1 to 31-N.

When the semiconductor Integrated circuit is in a refresh state or an idle state, the controller 40 may selectively activate the first control signal ‘REFA’ and the second control signal ‘DIOFF’. For example, the controller 40 can generate the first control signal ‘REFA’ and the second control signal ‘DIOFF’ according to an auto refresh signal ‘AREF’, a self refresh signal ‘PSRF’, a reset signal ‘RST’, and an idle signal ‘IDL’.

The auto refresh signal ‘AREF’ denotes a refresh signal that can be supplied from an external system of the semiconductor Integrated circuit. The self refresh signal ‘PSRF’ denotes a refresh signal that can be generated at each period that is internally set by the semiconductor Integrated circuit. The idle signal ‘IDL’ denotes a signal that can be activated in the state of all bank precharge, i.e., when all the internal banks of the semiconductor Integrated circuit are in a precharge state.

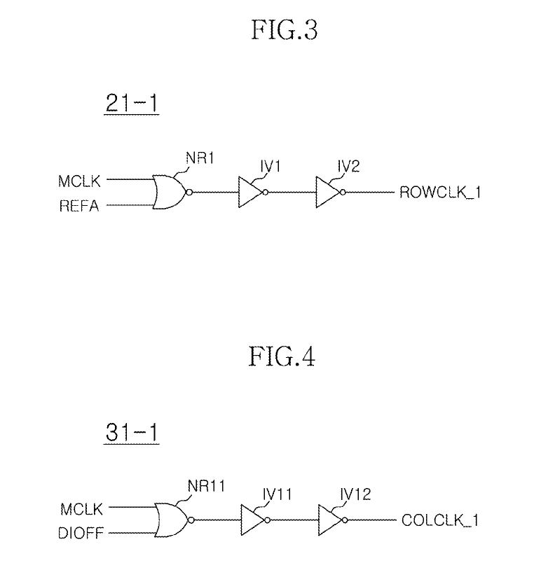

FIG. 3 is a schematic circuit diagram of an exemplary row clock driver capable of being implemented in the device of FIG. 2 according to one embodiment. As shown in FIG. 3, the clock driver 21-1 can be implemented for the row clock driver block 20 of FIG. 2, for example.

In FIG. 3, the clock driver 21-1 of the row clock driver block 20 can be configured to prevent toggling of the first clock signal ‘ROWCLK_1’ by fixing the first clock signal ‘ROWCLK_1’ to an inactive level, i.e., a low level, when the first control signal ‘REFA’ is activated. The clock driver 21-1 can include a NOR gate NR1, a first inverter IV1, and a second inverter IV2. Here, each of the clock drivers 21-2 to 21-N can be configured substantially similar to the clock driver 21-2.

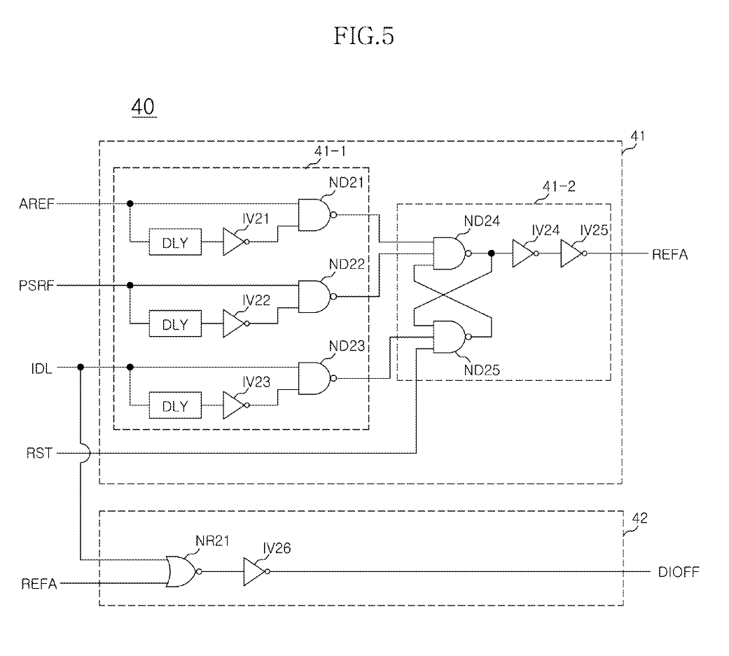

FIG. 4 is a schematic circuit diagram of an exemplary column clock driver capable of being implemented in the device of FIG. 2 according to one embodiment. As shown in FIG. 4, the clock driver 31-1 can be implemented for the column clock driver block 30 of FIG. 2, for example.

In FIG. 4, the clock driver 31-1 of the column clock driver block 30 can be configured to prevent toggling of the second clock signal ‘COLCLK_1’ by fixing the second clock signal ‘COLCLK_1’ to an inactive level, i.e., a low level, when the second control signal ‘DIOFF’ is activated. The clock driver 31-1 may include a NOR gate NR11, a first inverter IV11, and a second inverter IV12. Here, each of the clock drivers 31-2 to 31-N can be configured substantially similar to the clock driver 21-2.

FIG. 5 is a schematic circuit diagram of an exemplary controller capable of being implemented in the device of FIG. 2 according to one embodiment. As shown in FIG. 5, the controller 40 can be implemented for the controller 40 of FIG. 2, for example.

In FIG. 5, the controller 40 can include a first control signal generating unit 41 and a second control signal generating unit 42. The first control signal generating unit 41 can be constructed to generate the first control signal ‘REFA’ when the auto refresh signal ‘AREF’ or the self refresh signal ‘PSRF’ is activated, and can inactivate the first control signal ‘REFA’ when the reset signal ‘RST’ or the idle signal ‘IDL’ is activated.

The first control signal generating unit 41 can include a pulse generator 41-1 and a latch unit 41-2. The pulse generator 41-1 can receive the auto refresh signal ‘AREF’, the self refresh signal ‘PSRF’, and the idle signal ‘IDL’ to generate a row pulse signal. Here, the idle signal ‘IDL’ is a state signal that can maintain a certain level. Since a pulse signal with an appropriate width can be required for operation of the latch unit 41-2, the idle signal ‘IDL’ can be converted into a pulse signal form via the pulse generator 41-1. In addition, the auto refresh signal ‘AREF’ and the self refresh signal ‘PSRF’ can have a pulse width inappropriate for the operation of the latch unit 41-2. Accordingly, the auto refresh signal ‘AREF’ and the self refresh signal ‘PSRF’ can be enabled having an appropriate pulse width via the pulse generator 41-1. When the auto refresh signal ‘AREF’ and the self refresh signal ‘PSRF’ have the pulse width appropriate for the operation of the latch unit 41-2, a configuration of generating a pulse signal according to the auto refresh signal ‘AREF’ and the self refresh signal ‘PSRF’ can be eliminated from the configuration of the pulse generator 41-2.

The pulse generator 41-1 can include delay elements DLYs, inverters IV21, IV22, and IV23, and NAND gates ND21, ND22, and ND 23 for generating a pulse signal for each of the auto refresh signal ‘AREF’, the self refresh signal ‘PSRF’, and the idle signal ‘IDL’.

The latch unit 41-2 can be configured as an SR latch that can include a plurality of NAND gates ND24 and ND25, and a plurality of inverters IV24 and IV25.

The second control signal generating unit 42 can be configured to activate the second control signal ‘DIOFF’ when any one of the first control signal ‘REFA’ and the idle signal ‘IDL’ is activated. For example, the second control signal generating unit 42 may include a NOR gate NR21 and an inverter IV26.

An exemplary method of generating a clock signal of a semiconductor Integrated circuit will be described with reference to FIGS. 2 and 5.

An exemplary operation of the semiconductor Integrated circuit in a refresh state will be described. The auto refresh signal ‘AREF’ or the self refresh signal ‘PSRF’ can be activated according to an external refresh command or an internal refresh command. As the auto refresh signal ‘AREF’ or the self refresh signal ‘PSRF’ is activated, the first control signal generating unit 41 can activate the first control signal ‘REFA’. As the first control signal ‘REFA’ is activated, the second control signal generating unit 42 can activate the second control signal ‘DIOFF’.

Since the first control signal ‘REFA’ is activated, all the clock drivers 21-1 to 21-N included in the row clock driver block 20 can fix the first clock signals ‘ROWCLK<1:N>’ to an inactive level, i.e., a low level. Similarly, since the second signal ‘DIOFF’ is activated, all the clock drivers 31-1 to 31-N included in the column clock driver block 30 can fix the second clock signals ‘COLCLK<1:N>’ to an inactive level, i.e., a low level.

Accordingly, when the semiconductor Integrated circuit is in the refresh state, the first clock signals ‘ROWCLK<1:N>’ and the second clock signals ‘COLCLK<1:N>’ may not be required. Thus, it is possible to prevent toggling of the first clock signals ‘ROWCLK<1:N>’ and the second clock signals ‘COLCLK<1:N>’.

Next, an exemplary operation of the semiconductor Integrated circuit in the idle state, i.e., when all the banks of the semiconductor Integrated circuit are in the precharge state, will be described. When all the banks of the semiconductor Integrated circuit are in the precharge state, all the bank addresses can be inactivated, whereby the idle signal ‘IDL’ can be maintained at an active level, i.e., a high level.

As the idle signal ‘IDL’ is activated, the first control signal generating unit 41 can inactivate the first control signal ‘REFA’. When the first control signal ‘REFA’ is already in the inactivate state, the inactive state of the first control signal ‘REFA’ can be maintained. In addition, as the idle signal ‘IDL’ is activated, the second control signal generating unit 42 can activate the second control signal ‘DIOFF’.

Since the first control signal ‘REFA’ is inactivated, all the clock drivers 21-1 to 21-N included in the row clock driver block 20 can drive the output signal ‘MCLK’ of the clock buffer 1 to generate the first clock signals ‘ROWCLK<1:N>’. In addition, since the second control signal ‘DIOFF’ is activated, all the clock drivers 31-1 to 31-N included in the column clock driver block 30 can fix the second clock signals ‘COLCLK<1:N>’ to an inactive level, i.e., a low level.

Accordingly, when the semiconductor Integrated circuit is in the idle state, the first clock signals ‘ROWCLK<1:N>’ can be required. However, the second clock signals ‘COLCLK<1:N>’ may not be required. Thus, it is possible to prevent toggling of the second clock signals ‘COLCLK<1:N>’ while normally generating the first clocks signals ‘ROWCLK<1:N>’.

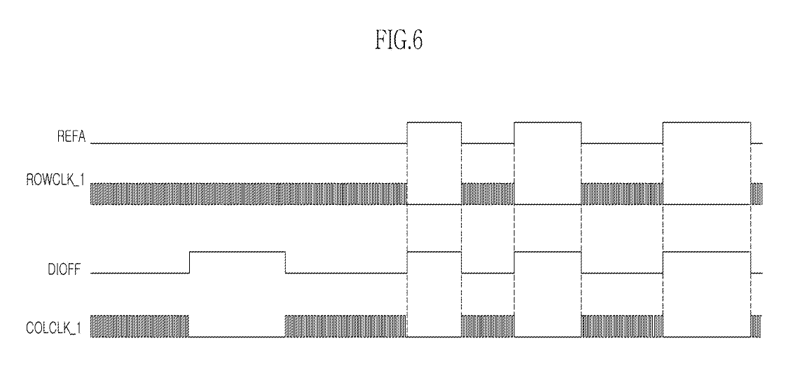

FIG. 6 is a waveform diagram of an exemplary clock signal according to one embodiment. In FIG. 6, toggling of the first clock signal ‘ROWCLK_1’ can be suspended in an active interval of the first control signal ‘REFA’, and toggling of the second clock signal ‘COLCLK_1’ can be suspended in an inactive interval of the second control signal ‘DIOFF’.

While certain embodiments have been described above, it will be understood that the embodiments described are by way of example only. Accordingly, the device and method described herein should not be limited based on the described embodiments. Rather, the devices and methods described herein should only be limited in light of the claims that follow when taken in conjunction with the above description and accompanying drawings.

What is claimed is:

1. An apparatus for generating a clock signal of a semiconductor Integrated circuit, the apparatus comprising:
a first clock driver block configured to generate a plurality of first clock signals;
a second clock driver block configured to generate a plurality of second clock signals; and
a controller configured to stop an operation of at least one of the first clock driver block and the second clock driver block when the semiconductor Integrated circuit is in a predetermined operational state.

2. The apparatus of claim 1, wherein the first clock driver block is configured to generate the plurality of first clock signals that is associated with a row operation of the semiconductor Integrated circuit.

3. The apparatus of claim 1, wherein the second clock driver block is configured to generate the plurality of second clock signals that is associated with a column operation of the semiconductor Integrated circuit.

4. The apparatus of claim 1, wherein the controller is configured to stop the operation of at least one of the first clock driver block and the second clock driver block when the semiconductor Integrated circuit is in one of a refresh state and an idle state.

5. The apparatus of claim 1, wherein the controller is configured to stop the operation of the first and the second clock driver blocks when the semiconductor Integrated circuit is in a refresh state,.

6. The apparatus of claim 1, wherein the controller is configured to stop the operation of the second clock driver block when the semiconductor Integrated circuit is in an idle state.

7. An apparatus for generating a clock signal of a semiconductor Integrated circuit, the apparatus comprising:
a first clock driver block configured to prevent toggling of a first clock signal in response to activation of a first control signal;
a second clock driver block configured to prevent toggling of a second clock signal in response to activation of a second control signal; and
a controller configured to activate at least one of the first control signal and the second control signal when the semiconductor Integrated circuit is in a predetermined operational state.

8. The apparatus of claim 7, wherein the first clock signal is a clock signal associated with a row operation of the semiconductor Integrated circuit, and the first clock driver block is configured to fix an output end of the first clock signal to a predetermined level in response to activation of the first control signal.

9. The apparatus of claim 7, wherein the second clock signal is a clock signal associated with a column operation of the semiconductor Integrated circuit, and the second clock driver block is configured to fix an output end of the second clock signal to a predetermined level in response to activation of the second control signal.

10. The apparatus of claim 7, wherein the controller is configured to activate at least one of the first control signal and the second control signal when the semiconductor Integrated circuit is in one of a refresh state and an idle state.

11. The apparatus of claim 7, wherein the controller is configured to activate the first control signal and the second control signal when the semiconductor Integrated circuit is in a refresh state.

12. The apparatus of claim 7, wherein the controller is configured to activate the second control signal when the semiconductor Integrated circuit is in an idle state.

13. The apparatus of claim 7, wherein the controller comprises:
a first control signal generating unit configured to generate the first control signal according to a self refresh signal and an idle signal; and
a second control signal generating unit configured to generate the second control signal according to the first control signal and the idle signal.

14. The apparatus of claim 13, wherein the first control signal generating unit activates the first control signal in response to activation of the self refresh signal, and inactivates the first control signal in response to activation of the idle signal.

15. The apparatus of claim 14, wherein the first control signal generating unit comprises:
a pulse generator receiving each of the self refresh signal and the idle signal to generate a pulse signal; and
a latch unit activating or inactivating the first control signal according to an output of the pulse generator.

16. The apparatus of claim 15, wherein the first control signal generating unit further comprises a first circuit configuration for activating the first control signal in response to activation of an auto-refresh signal, and a second circuit configuration for inactivating the first control signal in response to activation of a reset signal.

17. The apparatus of claim 13, wherein the second control signal generating unit is configured to generate the second control signal by performing a logical sum for the first control signal and the idle signal.

18. A method of generating a clock signal of a semiconductor Integrated circuit, the method comprising:
a decision operation of determining an operational state of the semiconductor Integrated circuit; and
a control operation of stopping generation of at least one of a plurality of first clock signals associated with a row operation of the semiconductor Integrated circuit and a plurality of second clock signals associated with a column operation of the semiconductor Integrated circuit when it is determined the operational state of the semiconductor Integrated circuit is in a predetermined operational state.

19. The method of claim 18, wherein the control operation stops generation of the first and the second clock signals when the operational state of the semiconductor Integrated circuit is in a refresh state.

20. The method of claim 18, wherein the control operation stops generation of the second clock signal when the operational state of the semiconductor Integrated circuit is in an idle state.

21. An apparatus for generating a clock signal of a semiconductor integrated circuit, the apparatus comprising:
a first clock driver block configured to generate a plurality of first clock signals;
a second clock driver block configured to generate a plurality of second clock signals; and
a controller configured to control an operation of each of the first and the second clock driver blocks according to an operational state of the semiconductor Integrated circuit.

22. The apparatus of claim 21, wherein the first clock driver block is configured to generate the plurality of first clock signals that is associated with a row operation of the semiconductor Integrated circuit.

23. The apparatus of claim 21, wherein the second clock driver block is configured to generate the plurality of second clock signals that is associated with a column operation of the semiconductor Integrated circuit.

24. The apparatus of claim 21, wherein the controller is configured to stop the operation of at least one of the first clock driver block and the second clock driver block when the semiconductor Integrated circuit is in one of a refresh state and an idle state.

25. The apparatus of claim 21, wherein the controller is configured to stop the operation of the first and the second clock driver blocks when the semiconductor Integrated circuit is in a refresh state.

26. The apparatus of claim 21, wherein the controller is configured to stop the operation of the second clock driver block when the semiconductor Integrated circuit is in an idle state.
